(19) United States
(12) Patent Application Publication
(10) Pub. No.: US 2010/0171783 A1
(43) Pub. Date: Jul. 8, 2010

(54) IMAGE RECORDING APPARATUS

(75) Inventors: Satoshi Kaiho, Kanagawa-ken (JP); Satoshi Kinouchi, Tokyo- to (JP); Nobuaki Takahashi, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/652,320

(22) Filed: Jan. 5, 2010

Related U.S. Application Data
(60) Provisional application No. 61/142,728, filed on Jan. 6, 2009.

(51) Int. Cl. B41J 29/38

(52) U.S. Cl. 347/16

(57) ABSTRACT

An image recording apparatus includes a carrying unit that carries a recording medium in a carrying direction. A recording head records on the recording medium carried by the carrying unit by ejecting ink. An application unit applies a treatment liquid to the recording medium carried by the carrying unit. An inclination correction unit is disposed on a downstream side in the carrying direction from the application unit and an upstream side in the carrying direction from the recording head and corrects an inclination of the recording medium carried by the carrying unit.

### CROSS-REFERENCE TO RELATED APPLICATIONS

This application is based upon and claims the benefit of priority from: U.S. Provisional Application No. 61/142,728 filed on Jan. 6, 2009, the entire contents of each of which are incorporated herein by reference.

### TECHNICAL FIELD

The present invention relates to an image recording apparatus for applying to a recording medium a treatment liquid—that shortens the time to fix ink to the recording medium.

### BACKGROUND

As an image recording apparatus, there is an ink jet recording apparatus having an ink jet head. The ink jet recording apparatus ejects ink from the ink jet head to record on a recording medium while carrying the recording medium such as a paper using a carrying unit. In the ink jet recording apparatus, in order to allow the ink to be quickly fixed onto the recording medium, a treatment liquid is applied to the recording medium before the ink is ejected from the ink jet head. A technique for applying a treatment liquid to a recording medium is disclosed in, for example, JP-A-2007-301817. In JP-A-2007-301817, a technique for applying the treatment liquid to a recording medium using a pair of rollers is disclosed.

However, when the arrangement positions of the pair of rollers deviate from the predetermined positions and an error occurs in the arrangement positions of the pair of application rollers, there may be a case where the recording medium is inclined from the regular direction while passing through the pair of application rollers. When the recording medium is carried to a location under the ink jet head while being inclined, the positional relationship between the recording medium and the ink jet head deviates. Accordingly, the quality of the recording medium on which an image is recorded deteriorates.

### SUMMARY

According to an aspect of the invention, an image recording apparatus comprises: a carrying unit that carries a recording medium in a carrying direction; a recording head that records on the recording medium carried by the carrying unit by ejecting ink; an application unit that applies a treatment liquid to the recording medium carried by the carrying unit; an inclination correction unit that is disposed on a downstream side in the carrying direction from the application unit and an upstream side in the carrying direction from the recording head and corrects an inclination of the recording medium carried by the carrying unit.

### DESCRIPTION OF THE DRAWINGS

FIG. 1 is a diagram illustrating a configuration of an image recording apparatus according to a first embodiment of the invention.

FIG. 2 is a diagram illustrating a configuration of an inclination correction unit of the apparatus in detail.

FIG. 3 is a flowchart of an inclination correction operation performed in the apparatus.

FIG. 4A is a top plan view illustrating a state where a recording medium is carried toward a correction roller while being inclined in the apparatus.

FIG. 4B is a side view illustrating the state where the recording medium is carried toward the correction roller while being inclined in the apparatus.

FIG. 5A is a top plan view illustrating the recording medium of which an inclination is corrected by the correction roller in the apparatus.

FIG. 5B is a side view illustrating the recording medium of which the inclination is corrected by the correction roller in the apparatus.

FIG. 6 is a diagram illustrating a configuration of an image recording apparatus according to a second embodiment of the invention.

### DETAILED DESCRIPTION

Hereinafter, a first embodiment of the invention will be described with reference to the accompanying drawings.

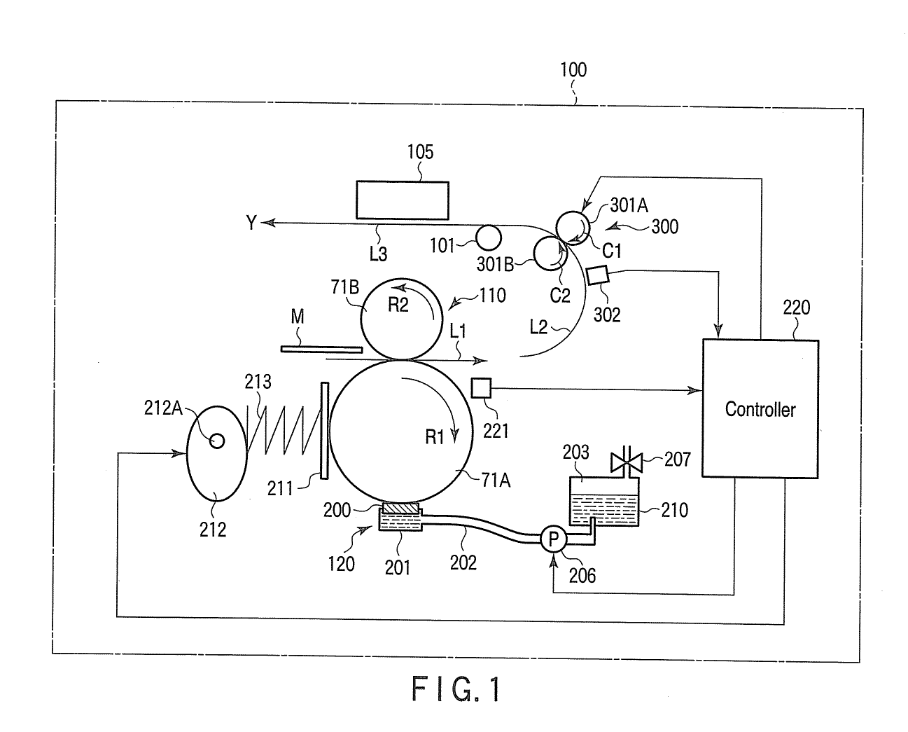

FIG. 1 is a diagram illustrating a configuration of an image recording apparatus. The image recording apparatus 100 is provided with carriage paths L1, L2, and L3. A recording medium M is carried on the carriage paths L1, L2, and L3. In the carriage path L3, a roller 101 is provided.

Above the carriage path L3, an ink jet head 105 is provided. The ink jet head 105 includes a plurality of ink ejection holes, and ink is ejected through each ink ejection hole. When the recording medium M is carried a location under the ink jet head 105, ink is ejected through each ink ejection hole of the ink jet head 105. The ink lands on the recording medium M to form an image.

In the carriage path L1 on an upstream side of a carrying direction of the ink jet head 105, an application unit 110 is provided. The application unit 110 applies a treatment liquid-10 to the recording medium M. The application unit 110 includes a pair of rollers 71A and 71B. The roller 71A is called an application roller. The roller 71A applies the treatment liquid 210 to the recording medium M. The roller 71B is called an opposed roller. The application roller 71A and the opposed roller 71B come in contact with each other and are rotated in arrow directions R1 and R2, respectively. The recording medium M is nipped between the application roller 71A and the opposed roller 71B to be carried.

The application roller 71A is provided with a contact application unit 120. The contact application unit 120 comes in contact with the application roller 71A to apply the treatment liquid 210 to the roller 71A. The contact application unit 120 includes a contact housing 201 and a porous member 200. The contact housing 201 temporarily stores the treatment liquid 210. The porous member 200 is impregnated with the treatment liquid 210 stored in the contact housing 201. The porous member 200 comes in surface contact with the application roller 71A to apply the treatment liquid 210 to a surface of the application roller 71A.

The treatment liquid 210 shortens a time to fix the ink on the recording medium M. The treatment liquid 210, for example, reacts with the ink on the recording medium M to allow the ink to agglutinate and maintain its color fixed. The treatment liquid 210 is a polymer solution such as carboxymethylcellulose, polyvinyl alcohol, and polyvinyl acetate.

The contact housing 201 is connected to a treatment liquid supplying tank 203 for example via a supplying tube 202. The treatment liquid supplying tank 203 stores the treatment liquid 210. The treatment liquid supplying tank 203 is provided with an air opening tube 214. The air opening tube 214 is provided with an air opening valve 207. The supplying tube 202 is provided with a pump 206.

An inclination correction unit 300 is disposed on a downstream side of the carrying direction from the application unit 110 and an upstream side of the carrying direction from the ink jet head 105 and is provided on the carriage path L3. After the treatment liquid 210 is applied to the recording medium M by the application unit 110, and before recording is performed on the recording medium M by the ink jet head 105, the inclination correction unit 300 corrects the recording medium M to a regular inclination. The regular inclination of the recording medium M is an inclination parallel with the carrying direction F.

The inclination correction unit 300 includes a pair of correction rollers 301A (first correction roller) and 301B (second correction roller) which are disposed in a direction perpendicular to the carrying direction of the recording medium M. The correction roller 301A is made of an elastic member. The correction roller 301B is made of a hard member. That is, the material of the second correction roller 301B is harder than that of the first correction roller 301A.

A recording medium sensor 302 is provided on an upstream side with respect to the carrying direction of the pair of correction rollers 301A and 301B. The recording medium sensor 302 detects the recording medium M carried on the carriage path L2. Specifically, the recording medium sensor 302 detects a front end or a rear end of the recording medium M carried on the carriage path L2 and outputs a detection signal of the front end or the rear end.

When the detection signal output from the recording medium sensor 302 is input to a controller 220, the controller 220 rotates the pair of correction rollers 301A and 301B after a predetermined period after the detection signal is input.

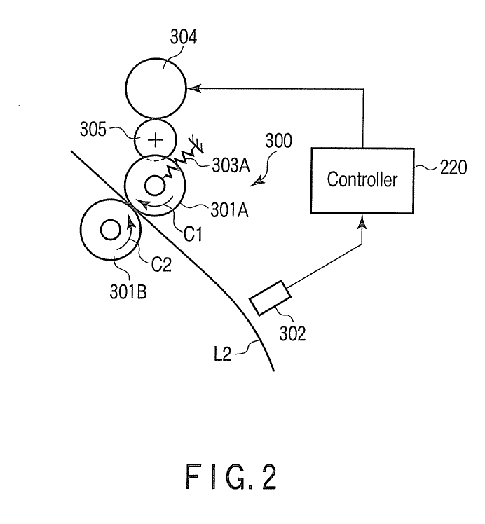

FIG. 2 illustrates a configuration of the inclination correction unit 300 in detail. The correction rollers 301A and 301B are provided with respective elastic members, for example, a spring 303A allow the first and second correction rollers 301A and 301B to come in pressing contact with each other.

The inclination correction unit 300 includes a motor 304. The motor 304 rotates the first correction roller 301A to allow the pair of correction rollers 301A and 3018 to rotate in arrow directions C1 and C2, respectively, while coming in contact with each other.

A clutch 305 is provided between the motor 304 and the first correction roller 301A. The clutch 305 transmits or intercepts the rotation of the motor 304 to, for example, the correction roller 301A.

The controller 220 opens the clutch 305 when power is supplied, and when the detection signal output from the recording medium sensor 302 is input, closes the clutch 305 after a predetermined period from the time of receiving the detection signal. Accordingly, after a predetermined period after the recording medium M is detected by the recording medium sensor 302, the rotation of the motor 304 is transmitted to the correction roller 301A via the clutch 305. Thereafter, when a time period for which one recording medium M is transmitted from among a plurality of sheets of recording media M sequentially carried elapses, the controller 220 opens the clutch 305. Accordingly, the rotation of the motor 304 is intercepted by the clutch 305 and is not transmitted to the correction roller 301A.

A cam 212 is provided to rotate around a shaft core 212A. The shaft core 212A is connected to a motor. The cam 212 has a restriction blade 211 with a spring 213 interposed therebetween. The restriction blade 211 comes in contact with the application roller 71A. A temperature sensor 221 detects a temperature of the vicinity of the recording medium M.

The controller 220 determines a pressing force needed for the restriction blade 211 on the basis of temperature information detected by the temperature sensor 221 so as to control the rotation of the cam 212. Accordingly, an application amount of the treatment liquid 210 to be applied to the application roller 71A is restricted by the restriction blade 211.

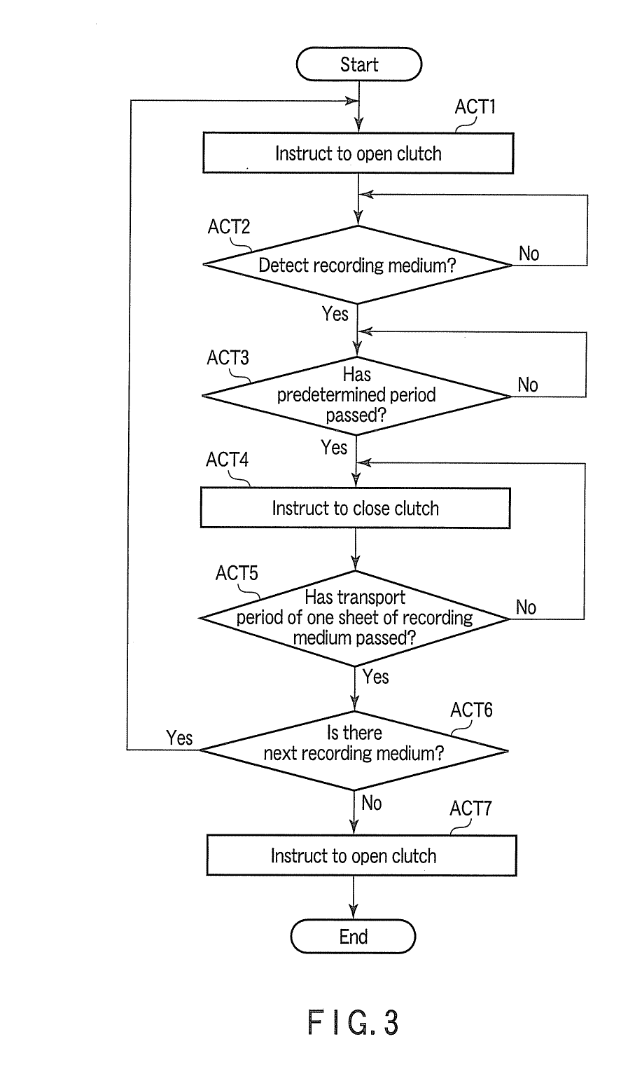

Next, an inclination correction operation of the recording medium M in the apparatus configured as described above will be described with reference to a flowchart of an inclination correction operation shown in FIG. 3.

When power is supplied, the controller 220 instructs the clutch 305 to open (Act 1). Accordingly, the rotation of the motor 304 is intercepted by the clutch 305 and is not transmitted to the correction roller 301A.

In this state, when the recording medium M is carried on the carriage path L1, the recording medium M is nipped and carried between the application roller 71A and the opposed roller 71B. The recording medium M is applied with the treatment liquid 210 from the application roller 71A. Here, when arrangement positions of the application roller 71A and the opposed roller 71B deviate from predetermined positions and an error occurs in the arrangement positions of the application roller 71A and the opposed roller 71B, the recording medium M is inclined from the regular inclination when it passes between the application roller 71A and the opposed roller 71B.

The recording medium M applied with the treatment liquid 210 is carried from the carriage path L2 to the carriage path L3. When the recording medium M is carried on the carriage path L2, the recording medium sensor 302 detects the front end of the recording medium M carried on the carriage path L2 and outputs the detection signal.

The controller 220 determines whether or not the detection signal output from the recording medium sensor 302 is input (Act 2). When it is determined that an input from the recording medium sensor 302 exists (Yes in Act 2), the controller 220 determines whether or not a predetermined time has passed from the time at which the detection signal is input (Act 3).

When it is determined that the predetermined period has not passed from the time at which the detection signal is input (No in Act 3), the controller 220 repeats the same determination operation until the predetermined period has passed. When the clutch 305 is in an opened state (No in Act 3), the rotation of the motor 304 is not transmitted to the correction roller 301A. The correction roller 301A is in a stopped state.

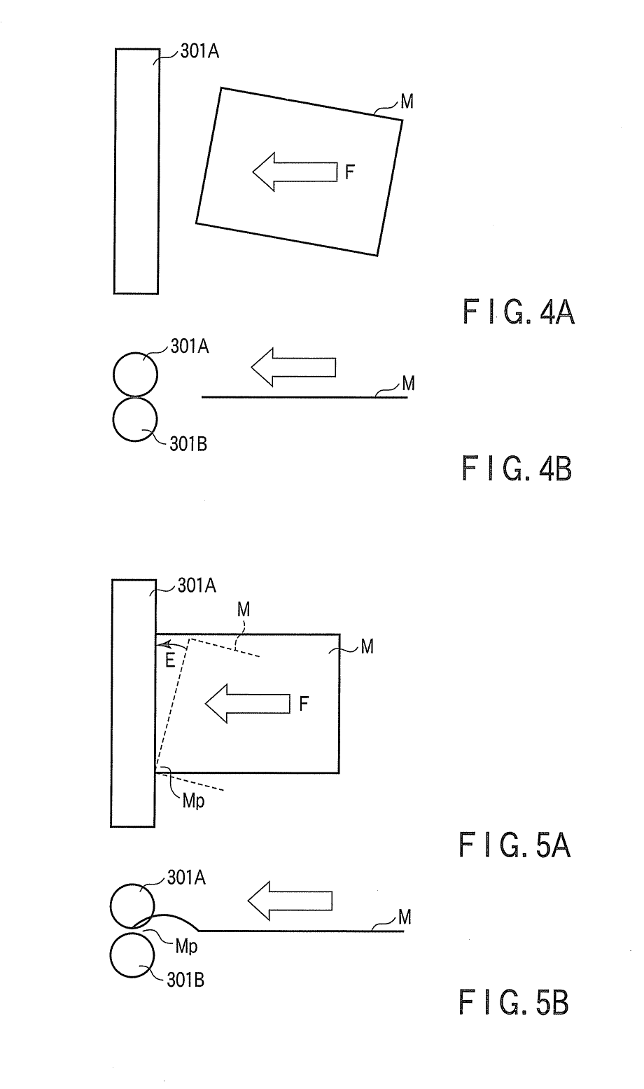

In this state, the recording medium M is carried toward the pair of correction rollers 301A and 301B while being inclined as illustrated in FIGS. 4A and 4B. FIG. 4A is a top plan view of the pair of correction rollers 301A and 301B and the recording medium M. FIG. 4B is a side view of the pair of correction rollers 301A and 301B and the recording medium M.

When the recording medium M comes in contact with the pair of correction rollers 301A and 301B that are stopped while being inclined, for example, as illustrated in FIGS. 5A and 5B, with regard to the recording medium M, a front end portion Mp in the carrying direction F initially comes in contact with the pair of correction rollers 301A and 301B, it is rotated in an arrow direction E relative to the front end portion Mp to be corrected to the regular inclination. Here, the front end portion Mp of the recording medium M is bent, for example, as illustrated in FIG. 5B.

When it is determined that the predetermined period has passed from the time at which the detection signal is input (Yes in Act 3), the controller 220 instructs the clutch 305 to close (Act 4). Accordingly, the rotation of the motor 304 is transmitted to the correction roller 301A via the clutch 305. As a result, the pair of correction rollers 301A and 301B sends the recording medium M to a location under the ink jet head 105. That is, the pair of correction rollers 301A and 301B is in the stopped state for a predetermined period after the recording medium M comes in contact, and after the predetermined period, starts to rotate so as to send the recording medium M to the location under the ink jet head 105.

The ink jet head 105 ejects ink from each ink ejection hole. The ink lands on the recording medium M to form an image.

The controller 220 determines whether or not a period for which one sheet of the recording medium M is carried has passed (Act 5). When the controller 220 determines that the period for which one sheet of the recording medium M is carried has passed (Yes in Act 5), it determines whether or not a next recording medium M exists (Act 6). When the controller 220 determines that the next recording medium M exists (Yes in Act 6), it returns to Act 1 to instruct the clutch 305 to open. When the controller 220 determines that there is no next recording medium M (No in Act 6), it instructs the clutch 305 to open (Act 7).

As described above, according to the first embodiment, the inclination correction unit 300 is provided for correcting the inclination of the recording medium M before recording is performed on the recording medium M by the ink jet head 105 after the treatment liquid 210 is applied to the recording medium M by the application roller 71A and the opposed roller 71B. Accordingly, even when the arrangement positions of the application roller 71A and the opposed roller 71B deviate from the predetermined positions and an error occurs in the arrangement positions of the application roller 71A and the opposed roller 71B so that the recording medium M is inclined while passing through the application roller 71A and the opposed roller 71B, the recording medium M is corrected to the regular inclination so as to be carried to the location under the ink jet head 105. There may be a case where the recording medium M is inclined while being carried on the carriage paths L1, L2, and L3 in addition to being inclined due to the error in the arrangement positions of the application roller 71A and the opposed roller 71B. The inclination correction unit 300 can correct an inclination of the recording medium M that occurs while passing on the carriage paths L1, L2, and L3 to the regular inclination. As a result, an image can be recorded on the recording medium M in a regular direction, so that it is possible to obtain the recording medium M with high quality.

Next, a second embodiment of the invention will be described with reference to the accompanying drawings.

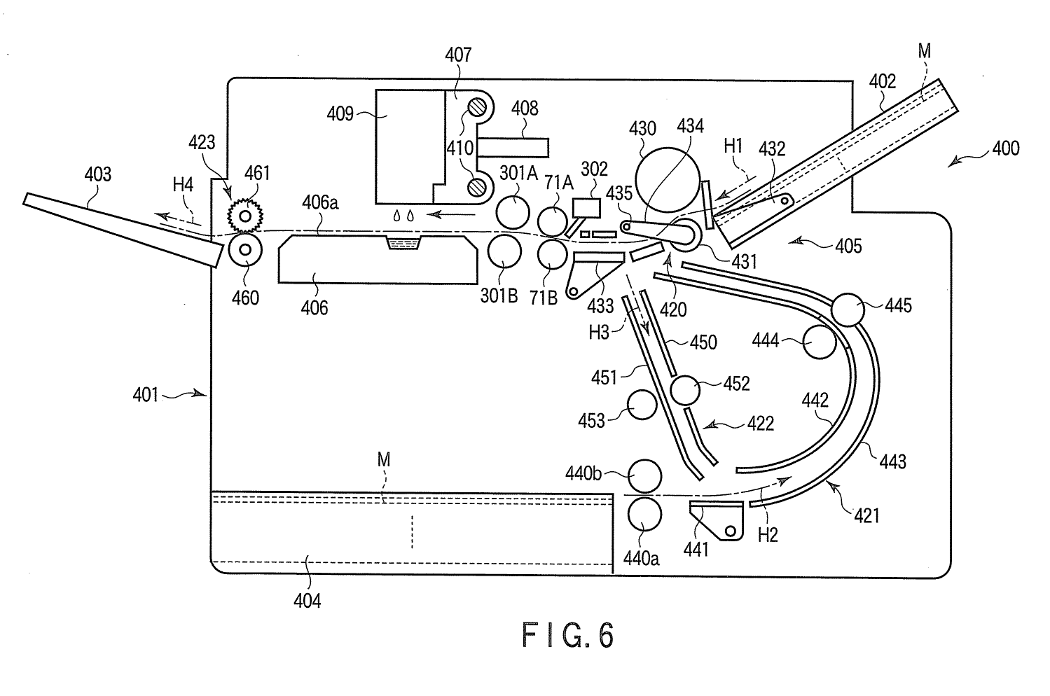

FIG. 6 is a diagram illustrating a configuration of an image recording apparatus. The image recording apparatus 400 includes an apparatus main body 401. A first supplying tray 402 is placed on one side of the apparatus main body 401 and a discharge tray 403 is placed on the other side thereof. A second supplying tray 404 is placed on a lower side of the apparatus main body 401. A plurality of sheets of recording media M having different sizes are accommodated in the first and second supplying trays 402 and 404.

A carrying mechanism 405 and a sheet guide 406 having a guide surface 406a are provided in the apparatus main body 401. Above the sheet guide 406, a carriage 407, a carriage driving mechanism 408 for driving the carriage 407, and an ink jet head 409 mounted in the carriage 407 are disposed.

The carriage driving mechanism 408 includes a carriage guide 410 extending in a horizontal direction. The carriage guide 410 extends in a direction perpendicular to the carrying direction of the recording medium M. The ink jet head 409 reciprocates in the direction perpendicular to the carrying direction of the recording medium M along the carriage guide 410 with the carriage 407.

The carrying mechanism 405 includes a first carrying unit 420, a second carrying unit 421, a two-sided printing carrying unit 422 used for two-sided printing, and a discharge mechanism 423.

The first carrying unit 420 carries the recording medium M supplied from the first supplying tray 402 toward the ink jet head 409. The first carrying unit 420 includes a supplying roller 430, a separation roller 431 disposed under the supplying roller 430, a separation unit 432, and a switching member 433. The supplying roller 430 supplies the recording medium M picked up from a lower end of the first supplying tray 402 toward the ink jet head 409.

When only one sheet of the recording medium M exists between the supplying roller 430 and the separation roller 431, the separation roller 431 rotates in the same direction as the supplying roller 430. When two or more sheets of the recording media M exist between the supplying roller 430 and the separation roller 431, the separation roller 431 rotates in a reverse direction to the supplying roller 430. Therefore, when plural sheets of the recording media M are picked up from the first supplying tray 402 and carried between the supplying roller 430 and the separation roller 431, the uppermost recording medium M and the other recording media M are separated. Only the uppermost recording medium M is supplied toward the ink jet head 409.

The separation roller 431 is held by a holder 434. The holder 434 is movable in a vertical direction around a shaft 435 extending in the horizontal direction. The separation roller 431 comes in contact with the supplying roller 430 by a spring at a predetermined load and separates from the supplying roller 430 by a cam. The separation unit 432 is movable in a direction to approach or separate from the supplying roller 430 by a cam. The separation roller 431 and the separation unit 432 separate from the supplying roller 430 and move to their respective standby positions after supplying the recording medium M and then wait for a next recording medium M to be supplied.

The switching member 433 switches between the first carrying unit 420, the second carrying unit 421, and the two-sided printing carrying unit 422.

The second carrying unit 421 carries the recording medium M supplied from the second supplying tray 404 toward the ink jet head 409. The second carrying unit 421 includes a pair of rollers 440a and 440b, a switching member 441, guide members 442 and 443, a carrying roller 444, and a pinch roller 445. The pair of rollers 440a and 440b picks up one sheet of the recording medium M at a time from the second supplying tray 404. The guide members 442 and 443 guide the carriage of the recording medium M picked up from the second supplying tray 404. The carrying roller 444 is provided for the guide members 442 and 443 to carry the recording medium M. The pinch roller 445 is opposed to the carrying roller 444. The pinch roller 445 comes in pressing contact with the carrying roller 444 by a spring.

The recording medium M supplied from the second supplying tray 404 is carried via the switching member 441 to the guide members 442 and 443 and is supplied between the ink jet head 409 and the sheet guide 406.

The switching member 441 switches between the first carrying unit 420 and the two-sided printing carrying unit 422 for a carriage path.

The two-sided printing carrying unit 422 includes guide members 450 and 451, a carrying roller 452 provided for the guide members 450 and 451, a pinch roller 453 opposed to the carrying roller 452, and the like. The guide members 450 and 451 are disposed between the switching member 433 of the first carrying unit 420 and the switching member 441 of the second carrying unit 421. The pinch roller 453 comes in pressing contact with the carrying roller 452 by a spring.

The discharge mechanism 423 discharges the recording medium M on which an image is recorded to the discharge tray 403. The discharge mechanism 423 includes a discharge roller 460, a star wheel 461, and the like. The recording medium M on which the image is recorded is carried toward the discharge tray 403 while coming in pressing contact with the discharge roller 460 by the star wheel 461.

An application roller 71A and an opposed roller 71B are provided between the switching member 433 of the first carrying unit 420 and the ink jet head 409. The application roller 71A is provided with a contact application unit 120 as in FIG. 1. The contact application unit 120 comes in contact with the application roller 71A and applies a treatment liquid to the application roller 71A. The application roller 71A applies the treatment liquid to the recording medium M. Although the contact application unit includes a contact housing and an application unit having a porous member, only the application roller 71A and the opposed roller 71B are shown in FIG. 6.

The pair of correction rollers 301A and 301B is provided between the application roller 71A and the ink jet head 409. The pair of correction rollers 301A and 301B, as described above, corrects the recording medium M to the regular inclination before recording is performed on the recording medium M by the ink jet head 409 after the treatment liquid 210 is applied to the recording medium M by the application roller 71A.

A peripheral structure of the pair of correction rollers 301A and 301B is the same as that of FIG. 2, so that detailed description thereof will be omitted. In addition, control operations of the controller are the same as those in FIG. 3, so that detailed description thereof will be omitted. In addition, effects of the correction rollers 301A and 301B on the recording medium M are the same as those of the first embodiment, detailed description thereof will be omitted.

A case where printing is performed on two sides of the recording medium M will be described.

An image is recorded on the recording medium M supplied from the first supplying tray 402 or the second supplying tray 404 by ejecting ink from the ink jet head 409. Here, the recording medium sensor 302 detects a rear end of the recording medium M on which the image is recorded and outputs a detection signal of the rear end.

When the detection signal of the rear end from the recording medium sensor 302 is input, after a predetermined period has passed from the time at which the detection signal of the rear end is input, the controller 220 carries the recording medium M in a reverse direction and switches the switching member 433 to the direction of the two-sided printing carrying unit 422. The recording medium M is carried in an arrow direction H3 between the guide members 450 and 451, delivered by the carrying roller 452 and the pinch roller 453, and carried to the second carrying unit 421 via the switching member 433. Accordingly, front and rear surfaces of the recording medium M are inverted.

The inverted recording medium M is carried in an arrow direction H2 on the second carrying unit 421 toward the application roller 71A and the opposed roller 71B.

As described above, the recording medium sensor 302 detects the recording medium M carried toward the application roller 71A and the opposed roller 71B and outputs a detection signal.

When the recording medium M is applied with the treatment liquid 210 from the application roller 71A again, if the arrangement positions of the application roller 71A and the opposed roller 71B deviate from the predetermined positions, the recording medium M is inclined while passing through the application roller 71A and the opposed roller 71B.

When the recording medium M, as illustrated in FIGS. 4A and 4B, comes in contact with pair of the correction roller 301A and 301B while being inclined from the regular direction for example, as illustrated in FIGS. 5A and 5B, the recording medium M is rotated in the arrow direction E relative to the front end portion Mp to be corrected to the regular direction. Thereafter, the pair of correction rollers 301A and 301B delivers the recording medium M to the location under the ink jet head 409.

As described above, according to the second embodiment, the inclination correction unit 300 for correcting the inclination of the recording medium M before recording is performed on the recording medium M by the ink jet head 409 after the treatment liquid 210 is applied to the recording medium M by the application roller 71A and the opposed roller 71B is provided in the image recording apparatus 400 including the first carrying unit 420, the second supplying tray 404, and the two-sided printing carrying unit 422. Therefore, the same effect as that of the first embodiment can be obtained.

There may be a case where the recording medium M is inclined in the first carrying unit 420, the second supplying tray 404, and the two-sided printing carrying unit 422. The inclination correction unit 300 can correct the inclination of the recording medium M that occurs in the first carrying unit 420, the second supplying tray 404, and the two-sided printing carrying unit 422 to the regular inclination. As a result, an image can be recorded on the recording medium M at the regular inclination, thereby obtaining the recording medium M with high quality.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording apparatus comprising:
a carrying unit that carries a recording medium in a carrying direction;
a recording head that records on the recording medium carried by the carrying unit by ejecting ink;
an application unit that applies a treatment liquid to the recording medium carried by the carrying unit;
an inclination correction unit that is disposed on a downstream side in the carrying direction from the application unit and an upstream side in the carrying direction from the recording head and corrects an inclination of the recording medium carried by the carrying unit.

2. The apparatus according to claim 1,
wherein the treatment liquid fixes quickly the ink.

3. The apparatus according to claim 1,
wherein the inclination correction unit includes a pair of rollers disposed in a direction perpendicular to the carrying direction of the recording medium.

4. The apparatus according to claim 3,
wherein the pair of rollers include a first roller formed an elastic material and a second roller formed a material harder than the first roller.

5. The apparatus according to claim 4, further comprising
a biasing member for allowing the first and second rollers to come in pressing contact with each other.

6. The apparatus according to claim 5,
wherein the biasing member includes a spring.

7. The apparatus according to claim 3,
wherein the inclination correction unit includes a controller for instructing to rotate the pair of rollers after a predetermined period after the recording medium comes in contact with the pair of rollers.

8. The apparatus according to claim 7,
wherein the inclination correction unit includes a recording medium detection unit that is disposed on an upstream side from the pair of rollers for detecting the recording medium.

9. The apparatus according to claim 1,
wherein the inclination correction unit includes:
a pair of rollers disposed in a direction perpendicular to the carrying direction of the recording medium;
a recording medium detection sensor that is disposed on an upstream side from the pair of rollers for detecting the recording medium; and
an inclination correction control unit that rotates the pair of rollers after a predetermined period after the recording medium is detected by the recording medium detection sensor.

10. The apparatus according to claim 9,
wherein the inclination correction control unit includes:
a motor;
a clutch that transmits or intercepts a rotation of the motor to the pair of rollers; and
a controller that controls the clutch to be in a interception state, and controls the clutch to be in a transmission state after the predetermined period after the recording medium is detected.

11. The apparatus according to claim 1,
wherein the inclination correction unit includes:
a pair of rollers that is arranged in a direction perpendicular to the carrying direction of the recording medium and includes a first roller formed an elastic material and a second roller formed a material harder than the first roller;
a spring that allows the first and second rollers to come to pressing contact with each other;
a motor that rotates the pair of rollers;
a clutch that transmits or intercepts the rotation of the motor to the pair of rollers;
a recording medium sensor that is disposed on an upstream side from the pair of rollers and detects the recording medium; and
a controller that controls the clutch to be in a interception state, and controls the clutch to be in a transmission state after the predetermined time after the recording medium is detected by the recording medium sensor.

12. The apparatus according to claim 1, further comprising:
an accommodation unit that accommodates the recording medium and supplies the recording medium to the carrying unit,
wherein the carrying unit includes:
a first carriage path that carries the recording medium supplied from the accommodation unit to a location under the recording head; and
a second carriage path that inverts the recording medium and carries the inverted recording medium to the location under the recording head after the recording medium is carried to the location under the recording head by the first carriage path.

13. The apparatus according to claim 12,
wherein the application unit applies a treatment liquid to the recording medium carried by the second carriage path, and
the inclination correction unit corrects the inclination of the recording medium applied with the treatment liquid by the application unit before recording is performed on the recording medium by the recording head.

14. An image recording apparatus comprising:
carrying means for carrying a recording medium in a carrying direction;
recording means for recording on the recording medium carried by the carrying means by ejecting ink;
application means for applying a treatment liquid to the recording medium; and
inclination correction means that is disposed on a downstream side in the carrying direction from the application means and on an upstream side in the carrying direction from the recording means for correcting an inclination of the recording medium.

15. The apparatus according to claim 14,
wherein the inclination correction means includes control means for instructing to rotate a pair of rollers which are arranged in a direction perpendicular to the carrying direction of the recording medium, after a predetermined period after the recording medium comes in contact with the pair of rollers.

16. The apparatus according to claim 15,
wherein the inclination correction means includes recording medium detection means that are disposed on an upstream side from the pair of rollers for detecting the recording medium.
